(19) United States
(12) Patent Application Publication
(10) Pub. No.: US 2025/0104022 A1
(43) Pub. Date: Mar. 27, 2025

(54) SYSTEM AND METHOD FOR CARDLESS TRANSACTION PROCESSING

(71) Applicant: FSA Store Inc., Dallas, TX (US)

(72) Inventors: Bhargav Shah, Southlake, TX (US); John Paul Wilkens, Cincinnati, OH (US)

(21) Appl. No.: 18/810,937

(22) Filed: Aug. 21, 2024

Related U.S. Application Data
(60) Provisional application No. 63/584,930, filed on Sep. 25, 2023.

(51) Int. Cl. G06Q 20/02; G06Q 20/22; G06Q 20/38; G06Q 20/40; G06Q 20/42

(52) U.S. Cl. CPC G06Q 20/02; G06Q 20/227; G06Q 20/382; G06Q 20/403; G06Q 20/407; G06Q 20/42

(57) ABSTRACT

A method for facilitating cardless transaction processing, including receiving a request for checkout, determining if a balance is sufficient, providing a frictionless payment option to a user, receiving a valid access token, receiving a valid bearer token, sending a payment request to a third party administrator, and processing the payment request.

### CROSS-REFERENCE TO RELATED APPLICATIONS

This application claims the benefit under 35 U.S.C. § 119 (e) of U.S. Provisional Application No. 63/584,930, filed Sep. 25, 2023, which application is incorporated herein by reference in its entirety.

### FIELD

The present disclosure relates generally to e-commerce, and more particularly, to e-commerce transactions that do not require a user to enter payment card credentials to complete a purchase, rather it is directly debited from the user's eligible flexible spending account, health savings account, or such other consumer driven health plan account.

### BACKGROUND

A flexible spending account (FSA), also known as a flexible spending arrangement, is one of a number of tax-advantaged financial accounts, resulting in payroll tax savings. The most common type of flexible spending account, the medical expense FSA (also medical FSA or health FSA), is similar to a health savings account (HSA) or a health reimbursement account (HRA). Paper forms or an FSA debit card may be used to access the account funds. The FSA debit card was developed to eliminate “double-dipping,” by allowing employees to access the FSA directly. It also simplified the substantiation requirement, which required labor-intensive claims processing. The debit card also enhances the effect of “pre-funding” medical FSAs. However, the substantiation requirement itself did not go away, and has even been expanded on by the Internal Revenue Service (IRS) for the debit-card environment; therefore, withdrawal issues still remain for FSAs. Current electronic commerce (E-commerce) companies have developed websites dedicated to FSA-eligible items, but fail to provide efficient transaction processing for users specifically in cases where the user does not have access to a FSA/HSA debit card, have misplaced it, or simply was not issued one.

### SUMMARY

According to aspects illustrated herein, there is provided a system and method for facilitating purchase transaction processing without the need for a user to manually enter payment card information or the need for the user to even have a card whether they were not issued one, have a card but have misplaced it, or do not have access to it.

In an exemplary embodiment, the method for facilitating cardless transaction processing, comprising receiving a request for checkout, determining if a balance is sufficient, providing a frictionless payment option to a user, receiving a valid access token, receiving a valid bearer token, sending a payment request to a third party administrator, and processing the payment request.

In an exemplary embodiment, the method further comprises, if the balance is not sufficient, providing an additional payment option to the user. In an exemplary embodiment, the step of receiving a valid access token comprises determining if a refresh token has expired, determining if an existing access token has expired, and if the existing access token has not expired, using the existing access token as the valid access token. In an exemplary embodiment, the method further comprises, if the refresh token has expired, directing the user to a log in portal. In an exemplary embodiment, the method further comprises, if the existing access token has expired, requesting a refresh token, issuing a new access token and a new refresh token, and using the new access token as the valid access token.

In an exemplary embodiment, the step of receiving a valid bearer token comprises determining if an existing bearer token has expired, and if the existing bearer token has not expired, using the existing bearer token as the valid bearer token. In an exemplary embodiment, the method further comprises, if the existing bearer token has expired, requesting authorization, requesting a new bearer token, issuing a new bearer token, and using the new bearer token as the valid bearer token. In an exemplary embodiment, the method further comprises after the step of processing the payment request, and determining whether the user consents to the payment. In an exemplary embodiment, the method further comprises after the step of processing the payment request, and determining if an error has occurred.

In an exemplary embodiment, the method further comprises after the step of processing the payment request, and determining if an insufficient payment has been received. In an exemplary embodiment, the method further comprises after the step of processing the payment request, and determining if a partial payment is required. In an exemplary embodiment, the method further comprises determining that a partial payment is required, and initiating a refund to the user if the partial payment information is either not provided in a stipulated amount of time or is declined. In an exemplary embodiment, the method further comprises, after the step of initiating a refund to the user, providing an additional payment option to the user. In an exemplary embodiment, the step of sending the payment or refund request to the TPA comprises sending the valid access token, a member identification, a transaction identification, and an order identification to the TPA.

According to aspects illustrated herein, there is provided a computer system for facilitating cardless transaction processing, comprising one or more computer processors, one or more computer readable storage media, program instructions stored on the computer readable storage media for execution by at least one of the one or more computer processors, the program instructions comprising program instructions to receive a request for checkout, program instructions to determine if a balance is sufficient, program instructions to provide a frictionless payment option to a user, program instructions to receive a valid access token, program instructions to receive a valid bearer token, program instructions to send a payment request to a third party administrator, and program instructions to process the payment request.

In an exemplary embodiment, the program instructions further comprise program instructions to, if the balance is not sufficient, provide an additional payment option to the user. In an exemplary embodiment, the program instructions to receive a valid access token comprise program instructions to determine if a refresh token has expired, program instructions to determine if an existing access token has expired, and program instructions to, if the existing access token has not expired, use the existing access token as the valid access token.

In an exemplary embodiment, the program instructions further comprise program instructions to, if the refresh token has expired, directing the user to a log in portal. In an exemplary embodiment, the program instructions further comprise program instructions to, if the existing access token has expired, request a refresh token, program instructions to issue a new access token and a new refresh token, and program instructions to use the new access token as the valid access token. In an exemplary embodiment, the program instructions to receive a valid bearer token comprises program instructions to determine if an existing bearer token has expired, and program instructions to, if the existing bearer token has not expired, use the existing bearer token as the valid bearer token.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a functional block diagram illustrating an environment, in accordance with some embodiments of the present disclosure.

FIG. 2 is a flow chart depicting operational steps for cardless transaction processing.

FIG. 2A is a flow chart depicting operational steps for cardless transaction processing.

FIG. 3 is a flow chart depicting operational steps for cardless transaction processing.

FIG. 4 is a flow chart depicting operational steps for cardless transaction processing.

FIG. 5 is a flow chart depicting operational steps for cardless transaction processing.

FIG. 6 is a flow chart depicting operational steps for cardless transaction processing.

FIG. 7 is a flow chart depicting operational steps for cardless transaction processing.

FIG. 8 is a flow chart depicting operational steps for cardless transaction processing.

FIG. 9 is a flow chart depicting operational steps for cardless transaction processing.

FIG. 10 is a flow chart depicting operational steps for cardless transaction processing.

FIG. 11 is a flow chart depicting operational steps for cardless transaction processing.

FIG. 12 is a flow chart depicting operational steps for cardless transaction processing.

FIG. 13 is a block diagram of internal and external components of a computer system, in accordance with an exemplary embodiment of the present disclosure.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

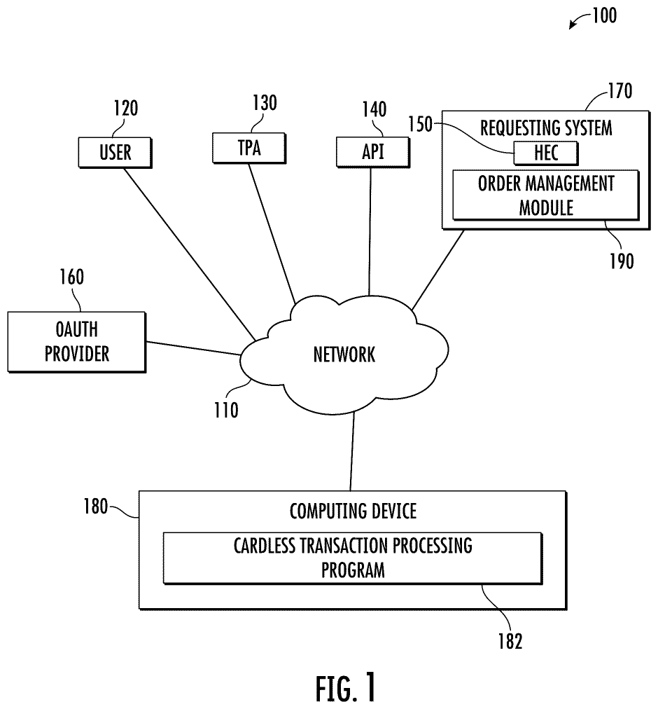

Referring now to the figures, FIG. 1 is a functional block diagram illustrating a cardless transaction processing environment, generally designated 100, in accordance with one embodiment of the present disclosure. FIG. 1 provides only an illustration of one implementation, and does not imply any limitations with regard to the environments in which different embodiments may be implemented. Many modifications to the depicted environment may be made by those skilled in the art without departing from the scope of the disclosure as recited by the claims. In an exemplary embodiment, environment 100 includes user third party administrator (TPA) 130, open authentication (OAuth) provider 160, application programming interface (API) 140, health-ecommerce (HEC) retailer 150, and computing device 180 all of which are connected to network 110. In an exemplary embodiment, environment 100 further comprises requesting system 170 connected to network 110. In an exemplary embodiment, network 110 further comprises user 120 capable of communicating with network 110. In an exemplary embodiment, network 110 further comprises order management module 190 connected to network 110.

Network 110 can be, for example, a local area network (LAN), a wide area network (WAN) such as the Internet, or a combination of the two, and can include wired, wireless, or fiber optic connections.

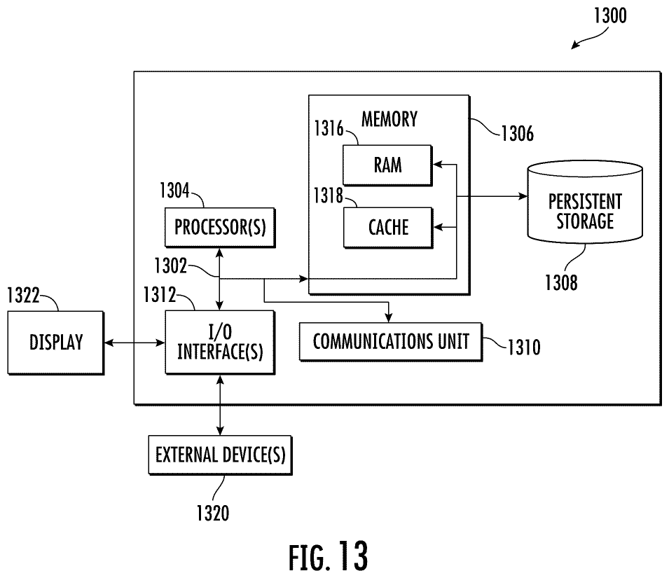

Computing device 180 may be a hardware device that receives data related to a user and communicates with various entities and components to fulfill purchase transactions without the need for purchase card information (e.g., FSA debit card, debit card, credit card, HSA debit card, etc.) using cardless transaction processing program 182. Computing device 180 is capable of communicating with network 110, user 120, TPA 130, API 140, HEC 150, OAuth provider 160, requesting system 170, and/or order management module 190. In an exemplary embodiment, computing device 180 may include a computer. In an exemplary embodiment, computing device 180 may include internal and external hardware components, as depicted and described in further detail with respect to FIG. 13. In an exemplary embodiment, cardless transaction processing program 182 is implemented on a web server, which may be a management server, a web server, or any other electronic device or computing system capable of receiving and sending data hosted either in-house or in the Cloud. The web server can represent a computing system utilizing clustered computers and components to act as a single pool of seamless resources when accessed through a network. The web server may include internal and external hardware components, as depicted and described in further detail with respect to FIG. 13.

Cardless transaction processing program 182 can coordinate input from multiple entities, for example, user 120, TPA 130, HEC 150, and/or requesting system 170 and fulfill a purchase transaction for user 120 without the need for the user to manually enter in card information or to access card information. Cardless transaction processing program 182 can generally include any software capable of authenticating user information without the need for debit/credit card information, and communicating with user 120, TPA 130, API 140, HEC 150, OAuth provider 160, requesting system 170, and/or order management module 190 over network 110 to receive real time data from the various entities and components.

TPA 130 is an organization that processes claims or certain aspects of employee benefit plans for a separate entity. In an exemplary embodiment, TPA 130 is an FSA or HSA administrator.

API 140 is an application programming interface allowing two or more computer programs to communicate with each other. API 140 is a type of software interface, offering a service to other pieces of software. In an exemplary embodiment, API 140 comprises MULESOFT® integration software.

Health E-commerce (HEC) retailer 150 is an E-commerce retailer of products eligible for purchase using FSA and/or HAS funds. In an exemplary embodiment, HEC retailer 150 comprises and/or provides an e-commerce platform or interface, for example, a landing page through which users can interact with respect to purchases and transactions.

OAuth provider 160 is an open standard authorization protocol or framework that provides applications the ability for secure designated access. OAuth provider 160 doesn't share password data but instead uses authorization tokens to prove an identity between user 120 and HEC 150. OAuth provider 160 is an authentication protocol that allows a user to approve one application interacting with another on the user's behalf without giving away a password. Specifically, OAuth provider 160 authenticates the identity of user 120 via TPA 130 in order to proceed with transactions using HEC 150.

Requesting system 170 is the e-commerce or order management system that sends the request for payment or refund to the integration platform (e.g., MULESOFT® integration software).

Order management module 190 is a platform or tool that allows sellers to track sales, process orders, manage inventory, and/or streamline fulfillment with the goal of making sure products end up in the hands of the customers who ordered them. In an exemplary embodiment, order management module 190 comprises SALESFORCE™ order management (SOM) software.

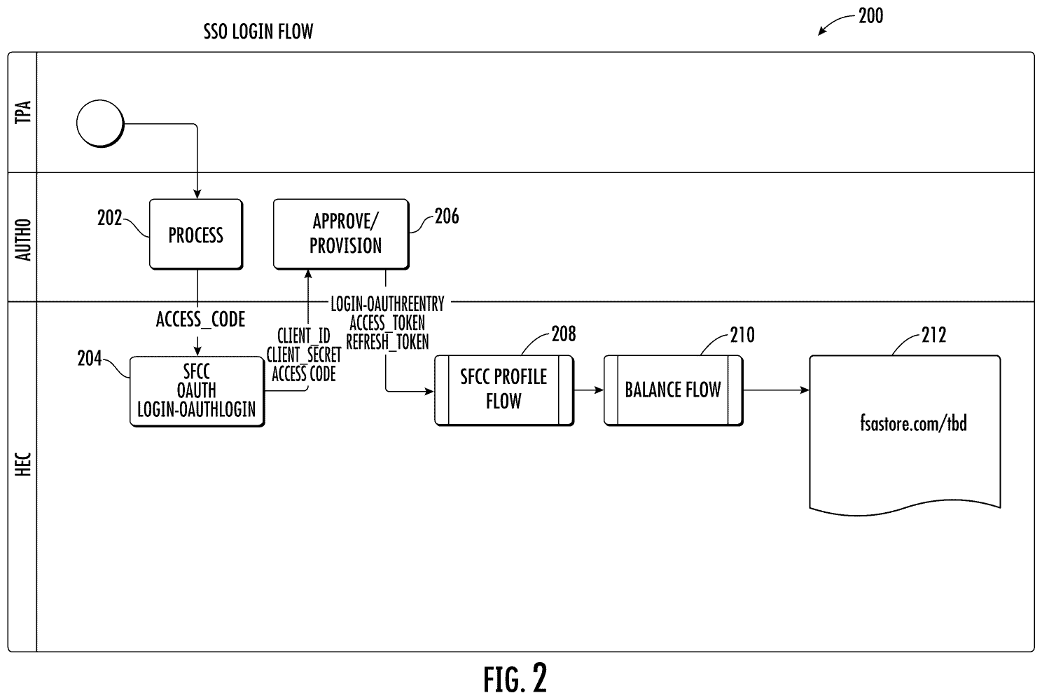

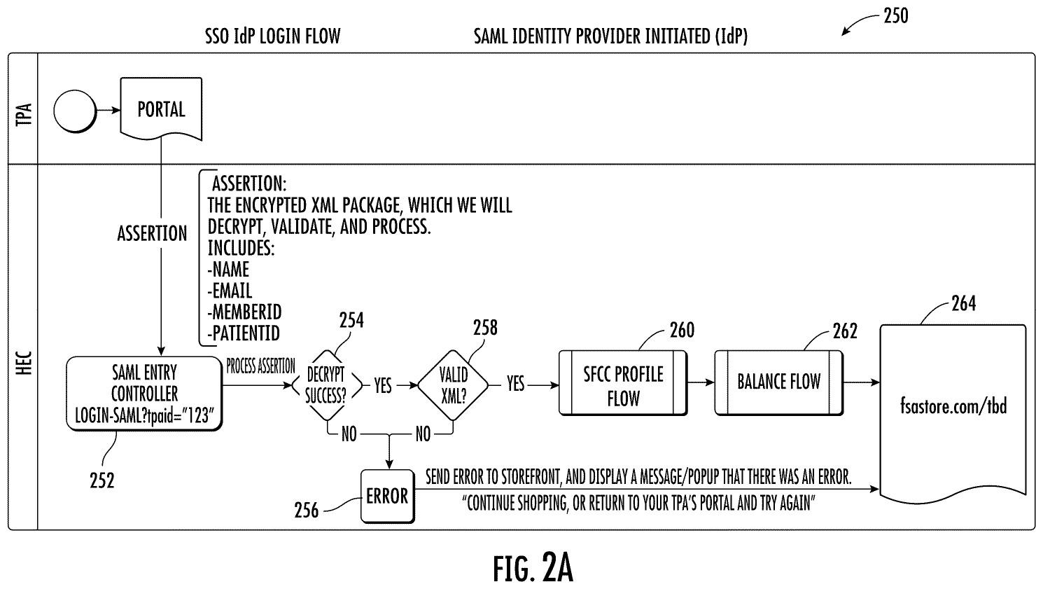

FIG. 2 shows flow chart 200 depicting operational steps for login flow.

In step 202, cardless transaction processing program 182 receives an input, for example, a request for login. For example, user 120 may click on a link to initiate the process. In an exemplary embodiment, the input is submitted by user 120 and occurs in a TPA portal provided by TPA 130. In an exemplary embodiment, cardless transaction processing program 182 directs the request to OAuth provider 160.

In step 204, cardless transaction processing program 182 directs OAuth provider 160 to generate and send an access code to HEC retailer 150. In an exemplary embodiment, the E-commerce platform comprises salesforce commerce cloud (SFCC). SFCC is utilized by HEC 150 to facilitate user authentication, E-commerce, and product purchases. In an exemplary embodiment, the access code is a unique code to the user profile that has a very short expiration (e.g., 30 seconds), which is the initial code provided. In an exemplary embodiment, a client identification and/or client secret code are generated, wherein the access code is provided with the client identification and/or the client secret code. The access code is utilized to obtain the initial refresh token and access token for the single sign-on (SSO) session, as will be described in greater detail below.

In step 206, cardless transaction processing program 182 directs the access code, client identification code, and/or client secret code for approval or provision. In an exemplary embodiment, the approval or provision of the access code, client identification code, and/or client secret code is performed by OAuth provider 160. Upon approval, cardless transaction processing program 182 generates a refresh token and an access token. In an exemplary embodiment, an access token is a unique token per profile that has a short expiration period (e.g., 1 hour), which can be used to make TPA API calls on behalf of that specific user. The access token contains user information, for example, a unified member identification, an email, a name, etc. In an exemplary embodiment, a refresh token is a unique token per profile that has a long expiration period (e.g., 6 months), which can be used to request new access tokens upon their expiration. Refresh tokens persist the “session” of the SSO login, as they can only be used once, and after using, a new refresh token will be provided, extending the session. Sessions will only end if no activity occurs within the expiration period.

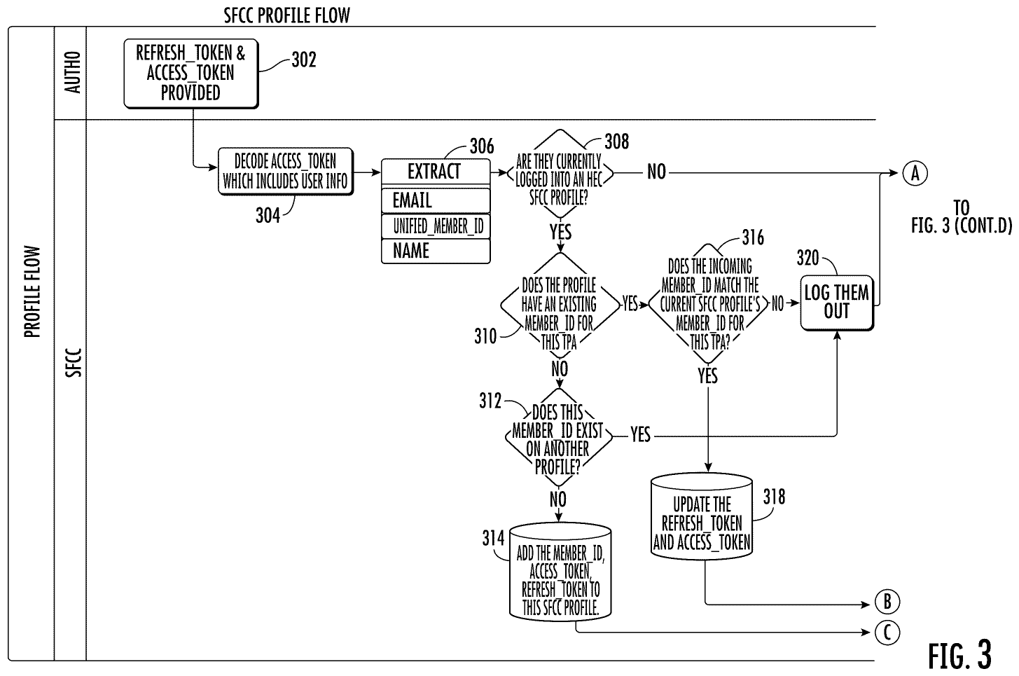

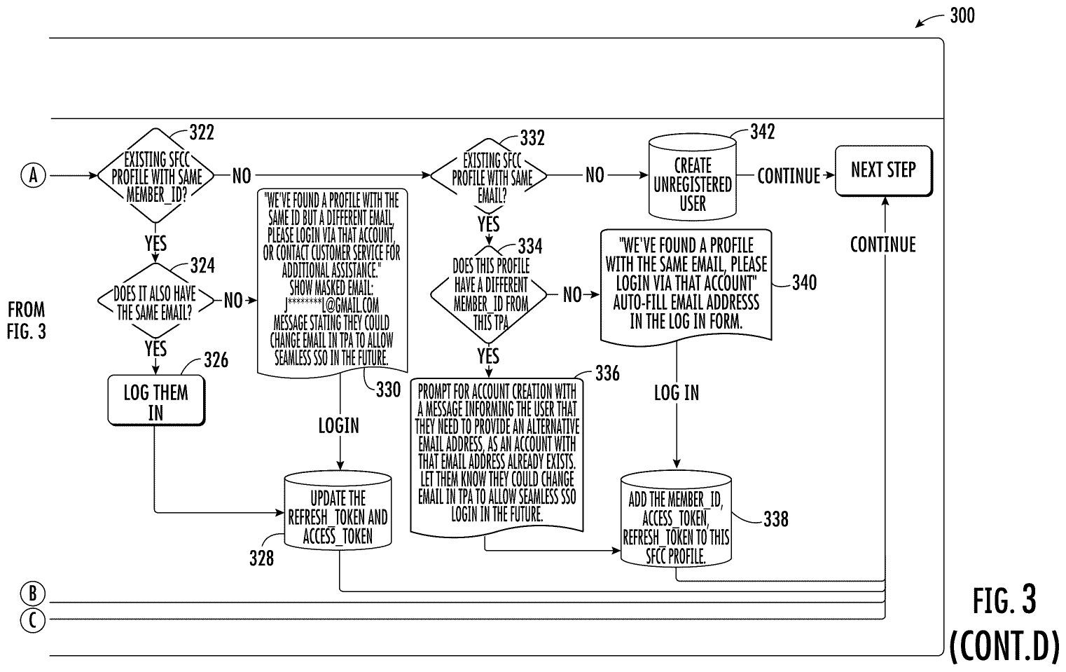

In step 208, cardless transaction processing program 182 proceeds to profile flow depicted by flow chart 300 and described with respect to FIG. 3.

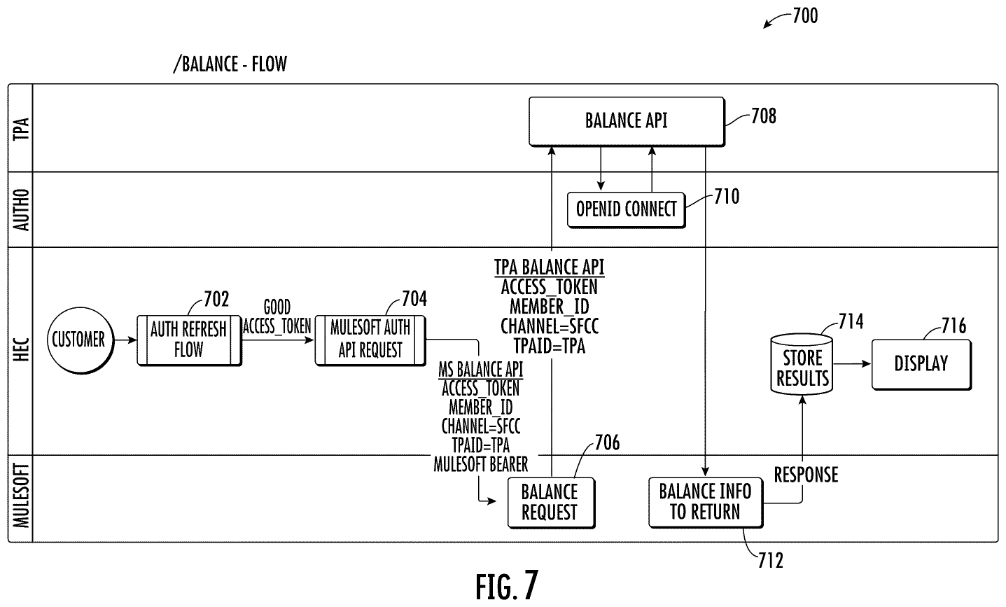

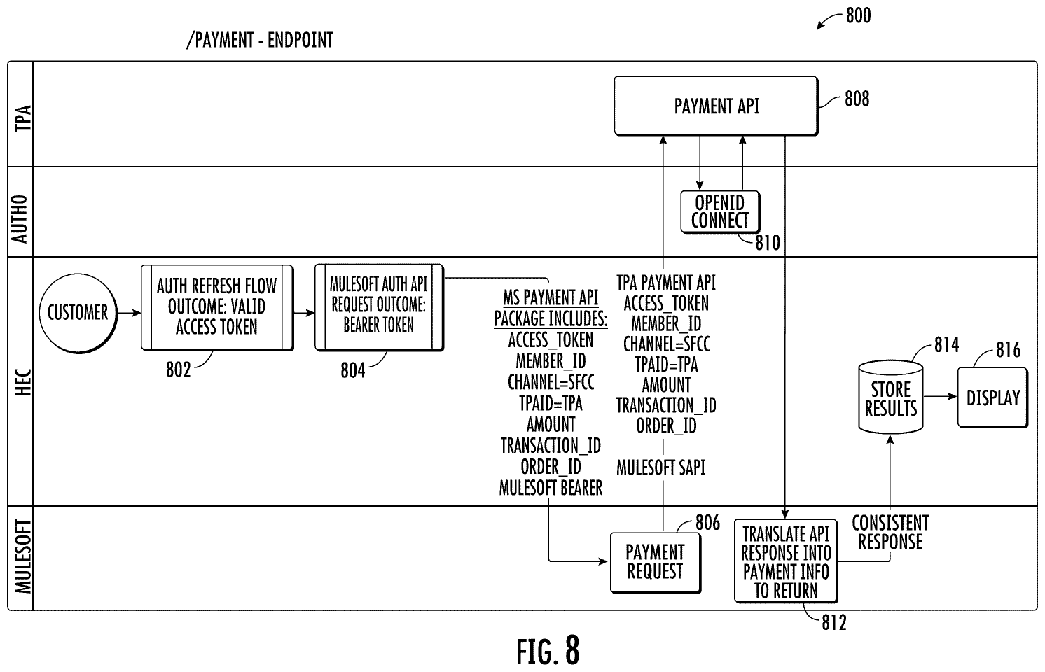

In step 210, cardless transaction processing program 182 proceeds to balance flow depicted by flow chart 700 and described with respect to FIG. 7.

In step 212, cardless transaction processing program 182 directs user 120 to a website for shopping for and purchasing items (e.g., a FSA store website). In an exemplary embodiment, the website is provided by HEC retailer 150.

FIG. 2A shows flow chart 250 depicting operational steps for login flow. In an exemplary embodiment, flow chart 250 depicts operational steps for login flow via security assertion markup language (SAML), which allows identity providers (IDPs) to pass authorization credentials to service providers.

In step 252, cardless transaction processing program 182 receives an input, for example, a request for login or login credentials, or an assertion. For example, user 120 may click on a link to initiate the process. In an exemplary embodiment, the input is submitted by user 120 and occurs in a TPA portal provided by TPA 130. In an exemplary embodiment, cardless transaction processing program 182 directs the request to HEC 150 and/or a SAML entry controller. In an exemplary embodiment, the assertion is an encrypted extensible markup language (XML) package, which is decrypted, validated, and processed. In an exemplary embodiment, the assertion may include a name, an email, a member ID, and/or a patient ID. Cardless transaction processing program 182 processes the assertion and decrypts the encrypted XML package therein.

In step 254, cardless transaction processing program 182 determines if the decryption of the process assertion was successful.

If, in step 254, cardless transaction processing program 182 determines that the decryption of the process assertion was not successful, then in step 256 cardless transaction processing program 182 indicates an error. In an exemplary embodiment, cardless transaction processing program 182 directs user 120 to a website for shopping for and purchasing items (e.g., a FSA store website) and displays a message/popup that an error has occurred. In an exemplary embodiment, cardless transaction processing program 182 displays a query to the user to either 1) continue shopping, or 2) return to the TPA's portal and try login again.

If, in step 254, cardless transaction processing program 182 determines that the decryption of the process assertion was successful, then in step 258 cardless transaction processing program 182 determines if the assertion contains a valid XML.

If, in step 258, cardless transaction processing program 182 determines that the assertion does not contain a valid XML, then in step 256 cardless transaction processing program 182 indicates an error, for example as described above.

If, in step 258, cardless transaction processing program 182 determines that the assertion does contain a valid XML, then in step 260 cardless transaction processing program 182 proceeds to profile flow depicted by flow chart 300 and described with respect to FIG. 3.

In step 262, cardless transaction processing program 182 proceeds to balance flow depicted by flow chart 700 and described with respect to FIG. 7.

In step 264, cardless transaction processing program 182 directs user 120 to a website for shopping for and purchasing items (e.g., a FSA store website). In an exemplary embodiment, the website is provided by HEC retailer 150.

FIG. 3 shows flow chart 300 depicting operational steps for profile flow or SFCC profile flow.

In step 302, cardless transaction processing program 182 provides the refresh token and the access token generated in step 206, for example, to OAuth provider 160.

In step 304, cardless transaction processing program 182 decodes the access token. As previously described, the access token includes user information.

In step 306, cardless transaction processing program 182 extracts user information, for example, an email address, a unified or unique member identification, a name, etc.

In step 308, cardless transaction processing program 182 determines if user 120 is logged into a HEC retailer profile.

If, in step 310, cardless transaction processing program 182 determines that user 120 is not logged into a HEC retailer profile, then in step 322 cardless transaction processing program 182 determines if there is an existing HEC profile with the same member identification.

If, in step 308, cardless transaction processing program 182 determines that user 120 is logged into a HEC retailer profile, then in step 310 cardless transaction processing program 182 determines if the user profile has an existing member identification for TPA 130.

If, in step 310, cardless transaction processing program 182 determines that the HEC retailer profile does not have an existing member identification for TPA 130, then in step 312 cardless transaction processing program 182 determines if the member identification exists on another profile.

If, in step 310, cardless transaction processing program 182 determines that the profile does have an existing member identification for TPA 130, then in step 316 cardless transaction processing program 182 determines if the incoming member identification matches the current HEC retailer profile's member identification for TPA 130.

If, in step 312, cardless transaction processing program 182 determines that the member identification does not exist on another profile, then in step 314 cardless transaction processing program 182 adds the member identification, access token, and refresh token to the HEC retailer profile.

If, in step 312, cardless transaction processing program 182 determines that the member identification does exist on another profile, then in step 320 cardless transaction processing program 182 logs user 120 out.

If, in step 316, cardless transaction processing program 182 determines that the incoming member identification matches the current HEC retailer profile's member identification for TPA 130, then in step 318 cardless transaction processing program 182 updates the refresh token and the access token.

If, in step 316, cardless transaction processing program 182 determines that the incoming member identification does not match the current HEC retailer profile's member identification for TPA 130, then in step 320 cardless transaction processing program 182 logs user 120 out.

If, in step 322, cardless transaction processing program 182 determines that there is not an existing HEC retailer profile with the same member identification, then in step 332 cardless transaction processing program 182 determines if there is an HEC retailer profile with the same email.

If, in step 322, cardless transaction processing program 182 determines that there is an existing HEC retailer profile with the same member identification, then in step 324 cardless transaction processing program 182 determines if there is an HEC retailer profile with the same name.

If, in step 324, cardless transaction processing program 182 determines that there is an existing HEC retailer profile with the same name, then in step 326 cardless transaction processing program 182 logs user 120 in.

In step 328, cardless transaction processing program 182 updates the refresh token and the access token.

If, in step 324, cardless transaction processing program 182 determines that there is not an existing HEC retailer profile with the same name, then in step 330 cardless transaction processing program 182 displays a message indicating such. For example, the message may indicate that a profile with the same member identification but a different email has been found, and direct user 120 to login via that account or contact customer service for additional assistance. The message may show the email address in a masked form. The message may indicate that user 120 could change the email address in TPA 130 to allow seamless SSO in the future.

If, in step 332, cardless transaction processing program 182 determines that there is not an existing HEC retailer profile with the same email, then in step 342, cardless transaction processing program 182 creates an unregistered user.

If, in step 332, cardless transaction processing program 182 determines that there is an existing HEC retailer profile with the same email, then in step 334 cardless transaction processing program 182 determines if the HEC retailer profile has a different member identification from TPA 130.

If, in step 334, cardless transaction processing program 182 determines that the HEC retailer profile has a different member identification from TPA 130, then in step 336 cardless transaction processing program 182 displays a message. In an exemplary embodiment, the message may include a request for account creation with a message informing the user that an alternative email address must be provided, as an account with that email address already exists. The message may further indicate the email can be changed in TPA 130 to allow seamless SSO login in the future.

In step 338, cardless transaction processing program 182 adds the member identification, access token, and refresh token to the HEC retailer profile.

If, in step 334, cardless transaction processing program 182 determines that the HEC retailer profile does not have a different member identification from TPA 130, then in step 340 cardless transaction processing program 182 displays a message. In an exemplary embodiment, the message may indicate that a profile with the same email has been found, and request that user 120 login via the that account. In an exemplary embodiment, cardless transaction processing program 182 may auto-fill the email address associated with the found profile into the login form.

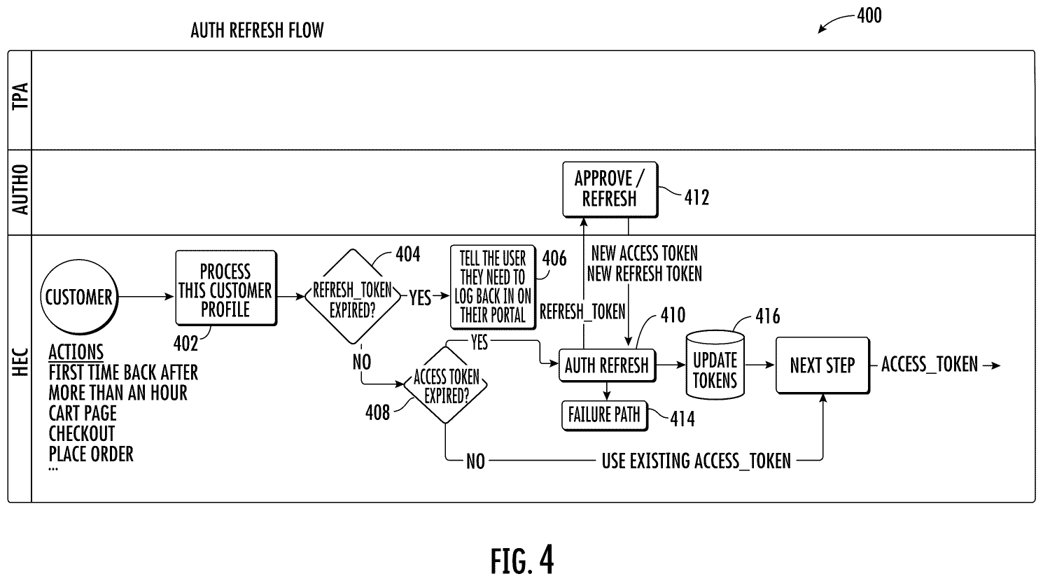

FIG. 4 shows flow chart 400 depicting operational steps for authorization refresh flow. The authorization refresh flow of chart 400 may be utilized when user 120 returns back to cardless transaction processing program 182 for the first time after a predetermined period of time (e.g., more than 1 hour), for example, to the cart page, the checkout page, or the place order page.

In step 402, cardless transaction processing program 182 directs the processing of the user's profile. In an exemplary embodiment, HEC retailer 150 processes the user profile.

In step 404, cardless transaction processing program 182 determines if the refresh token has expired.

If, in step 404, cardless transaction processing program 182 determines that the refresh token has expired, then in step 406 cardless transaction processing program 182 directs user 120 to log back in (e.g., via the portal).

If, in step 404, cardless transaction processing program 182 determines that the refresh token has not expired, then in step 408 cardless transaction processing program 182 determines if the access token has expired.

If, in step 408, cardless transaction processing program 182 determines that the access token has not expired, then cardless transaction processing program 182 uses the existing access token.

If, in step 408, cardless transaction processing program 182 determines that the access token has expired, then in step 410 cardless transaction processing program 182 initiates authorization refresh by sending the refresh token, for example, to OAuth provider 160.

In step 412, cardless transaction processing program 182 approves or refreshes the authorization and sends a new access token and a new refresh token, for example, to HEC retailer 150.

In case of failure of authorization refresh, cardless transaction processing program 182 proceed to a failure flow path in step 414.

In step 416, cardless transaction processing program 182 updates the tokens.

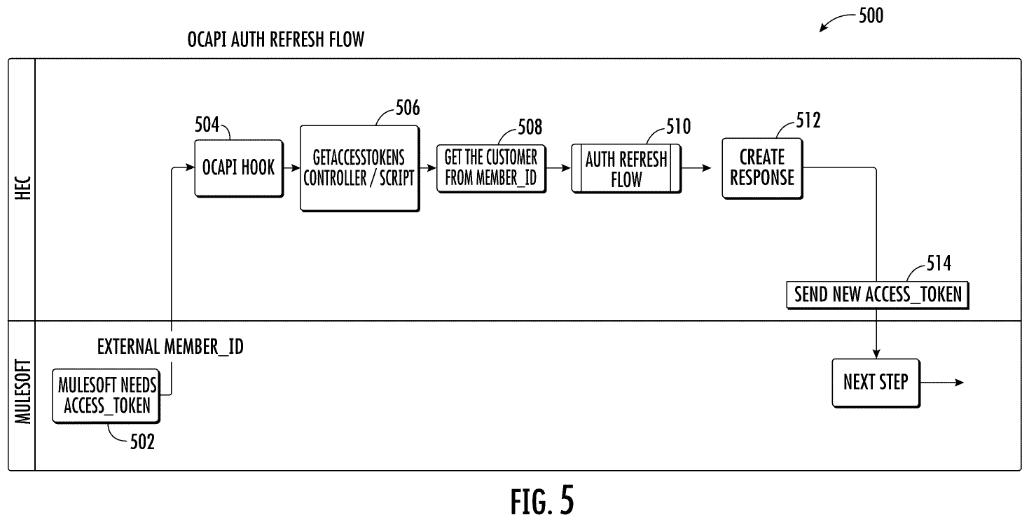

FIG. 5 shows flow chart 500 depicting operational steps for open commerce API (OCAPI) authorization refresh flow.

In step 502, cardless transaction processing program 182 requests an access token and sends an external member identification. In an exemplary embodiment, cardless transaction processing program 182 directs the external member identification be sent from API 140 to HEC retailer 150.

In step 504, cardless transaction processing program 182 creates a hook or hooks.

In step 506, cardless transaction processing program 182 receives access tokens controller/script.

In step 508, cardless transaction processing program 182 determines the user from the member identification.

In step 510, cardless transaction processing program 182 proceed with authorization refresh flow according to flow chart 400 in FIG. 4.

In step 512, cardless transaction processing program 182 creates a response.

In step 514, cardless transaction processing program 182 sends a new access token.

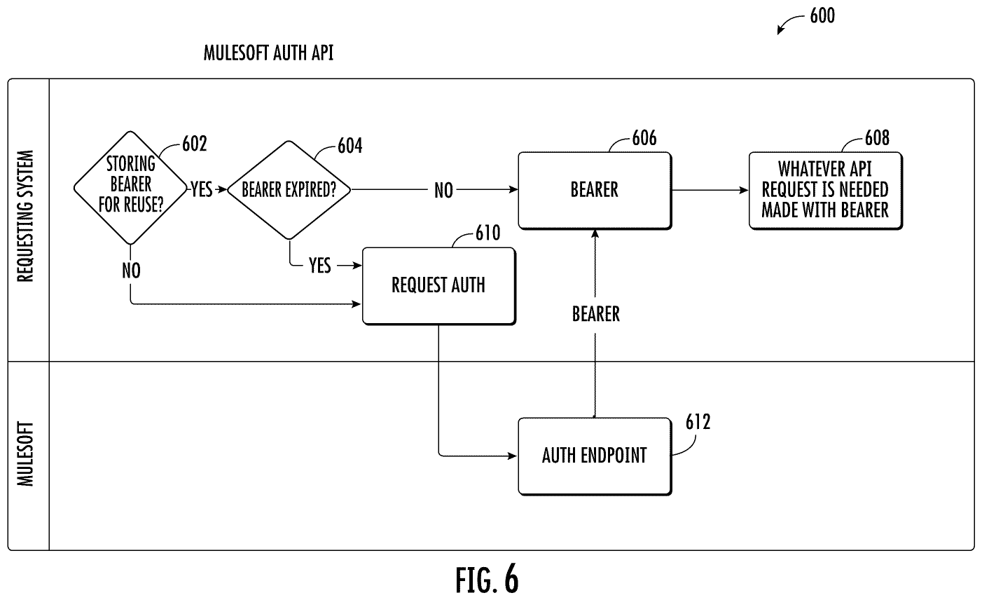

FIG. 6 shows flow chart 600 depicting operational steps for API authorization, for example, MULESOFT® API authorization.

In step 602, cardless transaction processing program 182 determines if the bearer token was successfully retrieved from API 140 and stored in requesting system 170. A bearer or bearer token is an authentication mechanism between e-commerce platform 150 or order management module 190 (i.e., the requesting system) and the integration platform.

If, in step 602, cardless transaction processing program 182 determines no bearer token is stored for reuse, then in step 610 cardless transaction processing program 182 requests authorization.

In step 612, cardless transaction processing program 182 provides a bearer token to requesting system 170 upon authorization (i.e., e-commerce platform 150 or order management module 190).

If, in step 602, cardless transaction processing program 182 determines that a bearer token is stored for reuse, then in step 604 cardless transaction processing program 182 determines if the bearer has expired.

If, in step 604, cardless transaction processing program 182 determines that the bearer has expired, then in step 610 cardless transaction processing program 182 requests authorization.

If, in step 604, cardless transaction processing program 182 determines that the bearer has not expired, then in step 606 cardless transaction processing program 182 uses that bearer token for the transaction.

In step 608, cardless transaction processing program 182 completes whatever API request (balance, payment, or refund) is needed to be made with the bearer token.

FIG. 7 shows flow chart 700 depicting operational steps for balance flow.

In step 702, cardless transaction processing program 182 completes authorization refresh flow, for example as shown in flow chart 400 in FIG. 4, and sends a valid access token.

In step 704, cardless transaction processing program 182 requests API authorization, for example the API authorization shown in flow chart 600 in FIG. 6. The API authorization request may include the access token, the member identification, and/or a bearer token. In an exemplary embodiment, the request is directed from HEC retailer 150 to API 140.

In step 706, cardless transaction processing program 182 requests a balance through API 140. The balance request may include the access token, the member identification, a channel=SFCC, tpaID=TPA. In an exemplary embodiment, the request is directed from API 140 to TPA 130.

In step 708, TPA 130 determines the balance of FSA and/or HSA funds for user 120.

In step 710, TPA 130 authenticates the API call made by API 140 using an identity provider such as Auth0. In an exemplary embodiment, TPA 130 utilizes openID connect (OIDC) from identity provider Auth0 to verify the identity of API 140 to ensure it is from a trusted source through credentials and/or access token and/or utilizing IP whitelisting.

In step 712, cardless transaction processing program 182 receives the balance information from TPA 130.

In step 714, cardless transaction processing program 182 stores the results or total balance, if it is the first time the balance information is received or updates the balance if there was a previously existing balance from a prior API call.

In step 716, cardless transaction processing program 182 displays the balance. In an exemplary embodiment, cardless transaction processing program 182 displays the balance on the HEC's website for that user.

FIG. 8 shows flow chart 800 depicting operational steps for payment flow.

In step 802, cardless transaction processing program 182 carries out authorization refresh flow, for example, for example as shown in flow chart 400 in FIG. 4, and sends a valid access token.

In step 804, cardless transaction processing program 182 carries out API authorization, for example the API authorization shown in flow chart 600 in FIG. 6, and sends a bearer token. In an exemplary embodiment, cardless transaction processing program 182 sends a payment package which includes, for example, the access token, member identification, channel=SFCC, tpaID=TPA, an amount, a transaction identification, an order identification, and/or a bearer token. In an exemplary embodiment, the transaction identification is a unique token for a specific API call only (i.e., a universally unique identifier (UUID) for this single API call). In an exemplary embodiment, the order identification is the original order number to link all transactions regarding this order. In an exemplary embodiment, the payment package is sent from HEC retailer 150 to API 140.

In step 806, cardless transaction processing program 182 generates a payment request. The payment request may include the access token, the member identification, channel=SFCC, tpaID=TPA, an amount, a transaction identification, and/or an order identification. In an exemplary embodiment, the payment request is sent to TPA 130.

In step 808, TPA 130 authorizes the payment.

In step 810, TPA 130 authenticates the API call made by API 140 using an identity provider such as Auth0. In an exemplary embodiment, TPA 130 utilizes OIDC from identity provider Auth0 to verify the identity of API 140 to ensure it is from a trusted source through credentials and/or access token and/or utilizing IP whitelisting.

In step 812, cardless transaction processing program 182 translates the API response into payment information to return for the order.

In step 814, cardless transaction processing program 182 stores the results or payment information.

In step 816, cardless transaction processing program 182 displays to user 120 an order confirmation if full payment has been authorized or a screen to input another payment method if partial payment amount has been authorized.

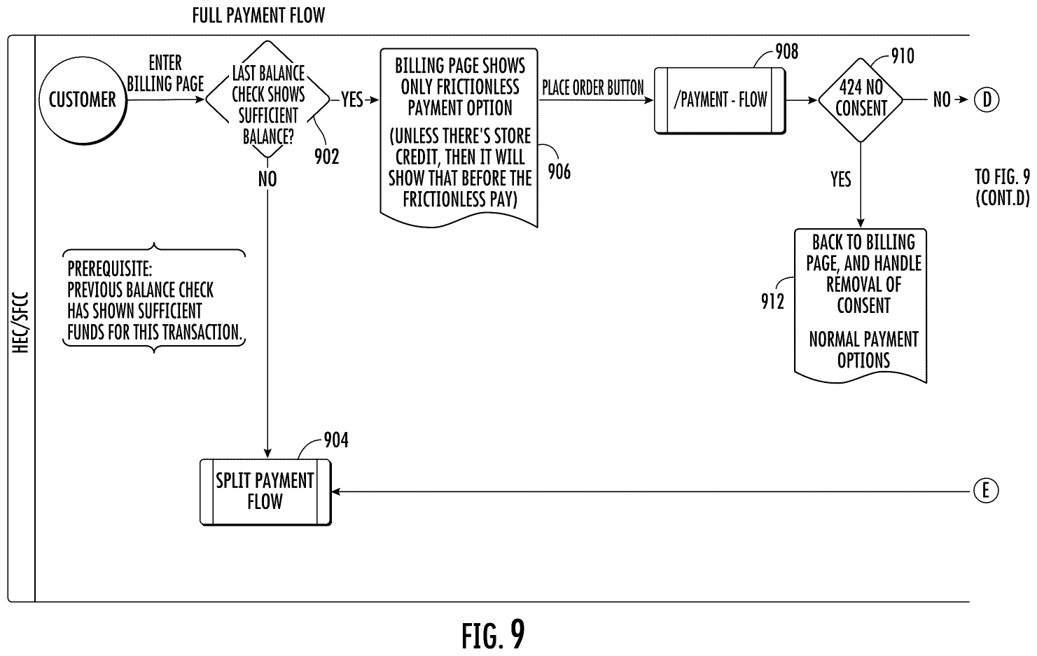

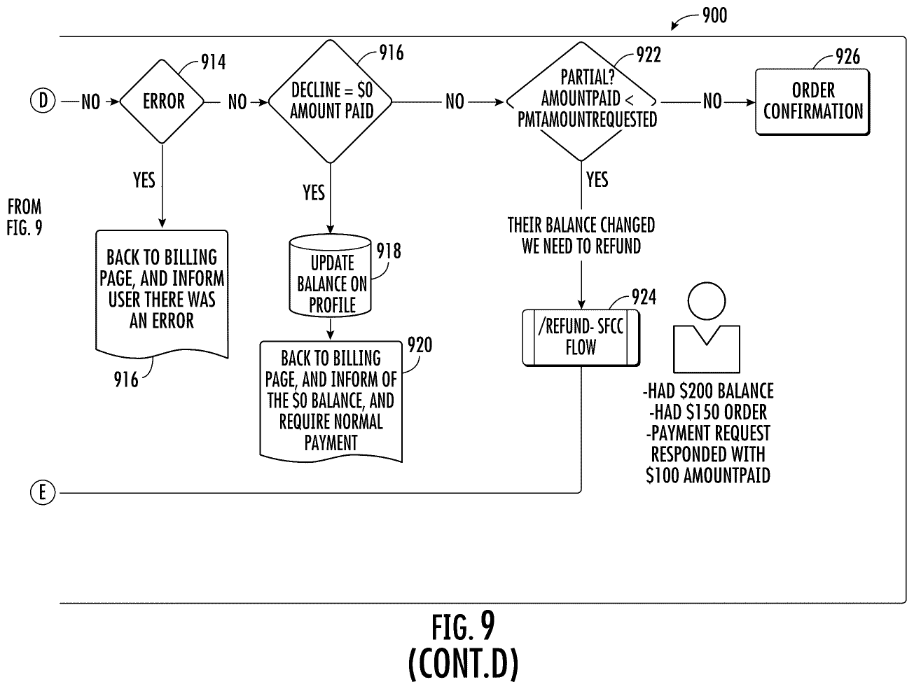

FIG. 9 shows flow chart 900 depicting operational steps for full payment flow.

In step 902, cardless transaction processing program 182 determines if the last balance check indicates sufficient balance. In an exemplary embodiment, a prerequisite for cardless transaction processing program 182 to proceed with full payment flow is that the previous balance check has shown sufficient funds for this transaction.

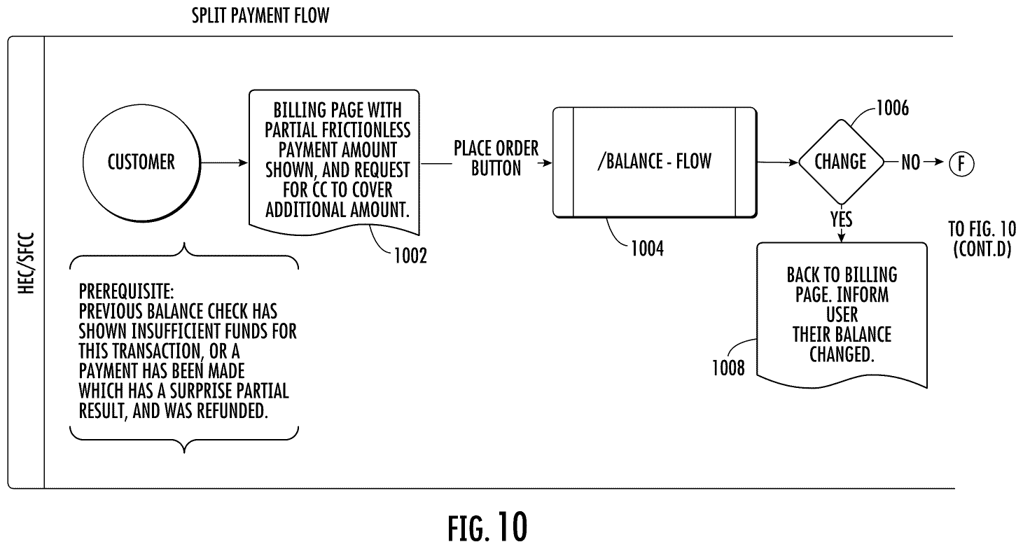

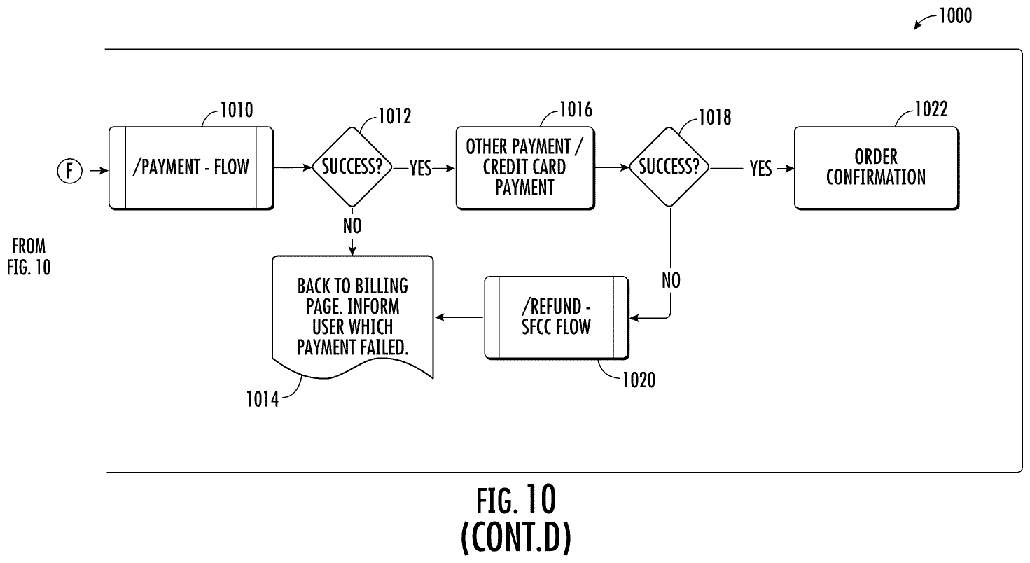

If, in step 902, cardless transaction processing program 182 determines that the last balance check does not indicate sufficient balance, then in step 904 cardless transaction processing program 182 proceeds to split payment flow, as described in greater detail with respect to flow chart 1000 shown in FIG. 10.

If, in step 902, cardless transaction processing program 182 determines that the last balance check indicates sufficient balance, then in step 906 cardless transaction processing program 182 shows only a frictionless payment option, for example, a frictionless payment option called DIRECTPAY™. In an exemplary embodiment, cardless transaction processing program 182 directs user 120 to a frictionless payment page. In an exemplary embodiment, if user 120 has existing store credit, cardless transaction processing program 182 will display the existing store credit before directing user 120 to the frictionless payment page.

In step 908, cardless transaction processing program 182 receives an indication that user 120 wants to place order and proceeds to payment flow, as described above with respect to flow chart 800 shown in FIG. 8. In an exemplary embodiment, the indication is from user 120 clicking on a place order button.

In step 910, cardless transaction processing program 182 determines if the consent for DIRECTPAY™ from user 120 is present or not.

If, in step 910, cardless transaction processing program 182 determines that there is no consent present or if the consent has expired, then in step 912 cardless transaction processing program 182 directs the user back to the billing page, where the user is directed to update their consent or proceed with normal payment options (e.g., card-based payment option such as a health card or credit card).

If, in step 910, cardless transaction processing program 182 determines that there is consent, then in step 914 cardless transaction processing program 182 determines if there is an error, which mean the transaction did not go through or has other issues.

If, in step 914, cardless transaction processing program 182 determines that there is an error, then in step 916 cardless transaction processing program 182 directs the user back to the billing page and indicates that an error has occurred.

If, in step 914, cardless transaction processing program 182 determines that there is no error, then in step 916 cardless transaction processing program 182 determines if decline=$0 amount paid, or an indication that there has been $0 amount paid (i.e., the user has no dollars left in their FSA, HSA, or other CDHP account for the purchase).

If, in step 916, cardless transaction processing program 182 determines that a decline has occurred or that $0 amount has been paid, then in step 918 cardless transaction processing program 182 updates the user's balance on the user's profile.

In step 920, cardless transaction processing program 182 directs the user back to the billing page and indicates that there is a $0 balance, and other payment method is required.

If, in step 916, cardless transaction processing program 182 determines that a decline has not occurred, then in step 922, cardless transaction processing program 182 determines if a partial payment has been received. In an exemplary embodiment, a partial payment has been received if the amount paid is greater than $0 and less than the amount requested (i.e., purchase amount on the order).

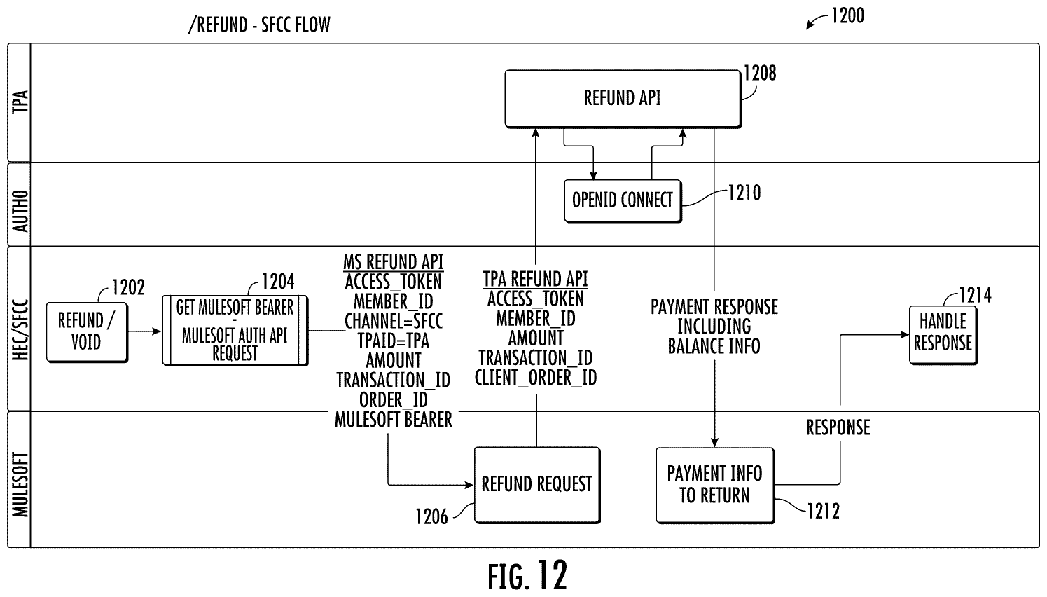

If, in step 922, cardless transaction processing program 182 determines that a partial payment has been received, then in step 924 cardless transaction processing program 182 proceeds with a refund flow, which will be described in greater detail below with respect to flow chart 1200 shown in FIG. 12. In an exemplary embodiment, the partial payment may indicate that the balance of the user's account has changed and a refund must be issued. For example, if user 120 had a $200 balance at the start of the payment transaction and a $150 order purchase amount, and the payment request responded with only $100 amount paid, user 120 must be refunded $100 (or the entire amount) and the payment flow would be restarted. Cardless transaction processing program 182 then proceeds with split payment flow, as described in greater detail with respect to flow chart 1000 shown in FIG. 10.

If, in step 922, cardless transaction processing program 182 determines that a partial payment has not been received (i.e., the full payment has been received), then in step 926 cardless transaction processing program 182 generates an order confirmation.

FIG. 10 shows flow chart 1000 depicting operational steps for split payment flow. In an exemplary embodiment, a prerequisite for cardless transaction processing program 182 to proceed with split payment flow according to flow chart 1000 is that the previous balance check has shown insufficient funds to cover the full order purchase amount for this transaction but shows that is there a balance in the account greater than $0, or a payment has been made which has a surprise partial result, and was refunded (as per steps 922 and 924 of flow chart 900).

In step 1002, cardless transaction processing program 182 directs user 120 to a billing page with partial frictionless payment amount shown, and a request for card information to cover the additional amount.

In step 1004, cardless transaction processing program 182 receives an indication that the user 120 wants to place an order and proceeds to balance flow, as described above with respect to flow chart 700 shown in FIG. 7. In an exemplary embodiment, the indication is from user 120 clicking on a place order button.

In step 1006, cardless transaction processing program 182 determines if a change has occurred in the user's balance.

If, in step 1006, cardless transaction processing program 182 determines that a change in the user's balance has occurred, then in step 1008 cardless transaction processing program 182 directs user 120 back to the billing page and indicates that the user balance has changed.

If, in step 1006, cardless transaction processing program 182 determines that a change in the user's balance has not occurred, then in step 1016 cardless transaction processing program 182 proceed with payment flow to capture the funds from the user's FSA, HSA, or other CDHP account(s), as described above with respect to flow chart 800 shown in FIG. 8.

In step 1012, cardless transaction processing program 182 determines if the payment was successful.

If, in step 1012, cardless transaction processing program 182 determines that the cardless/frictionless payment was not successful, then in step 1014 cardless transaction processing program 182 directs user 120 back to the billing page and indicates that the cardless/frictionless payment failed.

If, in step 1012, cardless transaction processing program 182 determines that the frictionless payment was successful, then in step 1016 cardless transaction processing program 182 processes the other payment method, for example, the remaining payment portion using the card.

In step 1018, cardless transaction processing program 182 determines if the card payment was successful.

If, in step 1018, cardless transaction processing program 182 determines that the card payment was not successful, then in step 1020 cardless transaction processing program 182 proceed with the refund SFCC flow, as will be described in greater detail with respect to flow chart 1200 shown in FIG. 12. Cardless transaction processing program 182 then proceed to step 1014 directing the user to the billing page and indicating that the card payment has failed, and the user needs to enter another card.

If, in step 1018, cardless transaction processing program 182 determines that the payment was successful, then in step 1022 cardless transaction processing program 182 generates an order confirmation.

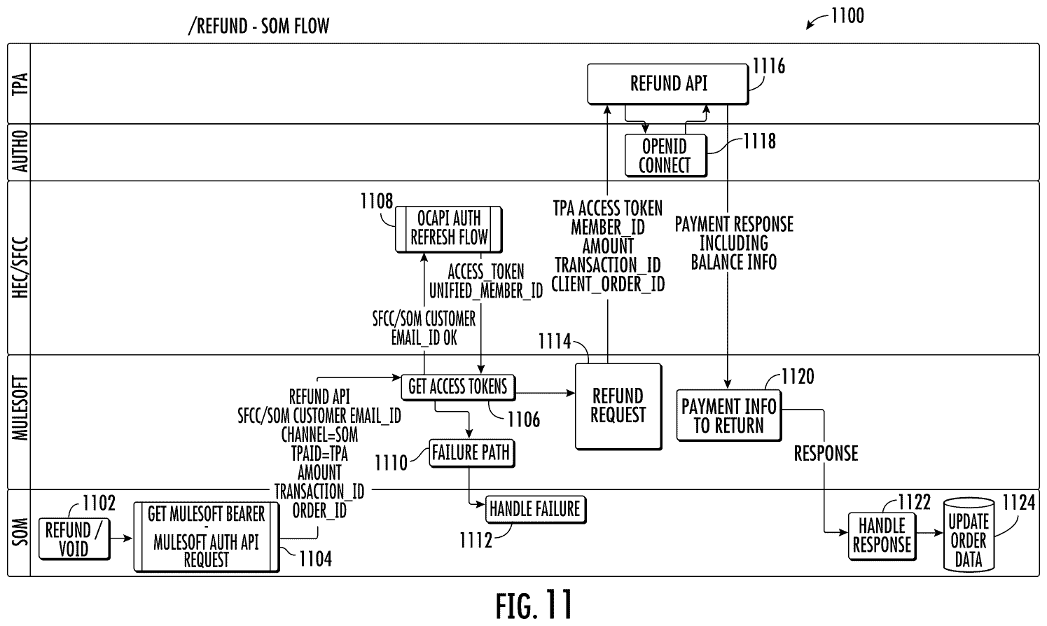

FIG. 11 shows flow chart 1100 depicting operational steps for refund SOM flow which is the refund flow “after” the order has already been placed and is in HEC's order management system 190.

In step 1102, cardless transaction processing program 182 initiates a refund or a void upon action by the user or customer service agent. This typically occurs when the customer (i.e., user 120) want to cancel an order or if the order was not fulfilled to the customer's satisfaction. The refund or cancel transaction is initiated by either the customer (user 120) or a customer service agent which triggers the refund SOM flow.

In step 1104, cardless transaction processing program 182 proceeds with API authorization (e.g., MULESOFT API authorization), as described above with respect to flow chart 600 shown in FIG. 6. In an exemplary embodiment, cardless transaction processing program 182 sends a refund request to API 140 that includes, for example, SFCC/SOM customer email identification, channel=SOM, tpaID=TPA, amount, transaction identification, and/or order identification.

In step 1106, cardless transaction processing program 182 retrieves access tokens from SFCC.

In step 1108, cardless transaction processing program 182 proceeds with OCAPI authentication refresh flow as described above with respect to flow chart 500 shown in FIG. 5. In an exemplary embodiment, cardless transaction processing program 182 directs SFCC/SOM customer email identification and tpaID to be sent from API 140 to HEC retailer 150. In an exemplary embodiment, cardless transaction processing program 182 directs the access token and the unified member identification generated in flow chart 500 to API 140.

If a failure occurs, cardless transaction processing program 182 proceeds to failure path 1110.

In step 1112, cardless transaction processing program 182 directs order management module 190 to handle the failure, which includes retrying the transaction and/or providing an error message to the customer service agent to manage the refund request with other methods outside the cardless transaction processing program 182.

In step 1114, cardless transaction processing program 182 sends a refund request to TPA 130. In an exemplary embodiment, the refund request comprises a TPA access token, a member identification, an amount, a transaction identification, and/or a customer (i.e., user 120) order identification.

In step 1116, TPA 130 authorizes the refund after authenticating the API call in step 1118.

In step 1118, TPA 130 authenticates the API call made by API 140 using an identity provider such as Auth0. In an exemplary embodiment, TPA 130 utilizes OIDC from Identity Provider Auth0 to verify the identity of API 140 to ensure it is from a trusted source through credentials and/or access token and/or utilizing IP whitelisting.

In step 1120, cardless transaction processing program 182 reports any payment information including balance information.

In step 1122 cardless transaction processing program 182 directs order management module 190 to handle the response. In an exemplary embodiment, cardless transaction processing program 182 determines if the order was cancelled and the refund issued or order was not cancelled and refund not issued.

In step 1124, cardless transaction processing program 182 updates order data in SOM database.

FIG. 12 shows flow chart 1200 depicting operational steps for refund SFCC flow.

In step 1202, cardless transaction processing program 182 initiates a refund or a void. This is triggered during step 924 or step 1020 (i.e., full payment flow or split payment flow, respectively) or if the user 120 (customer) canceled the order within few minutes of placing the order and before the order goes into Order Management Module 190.

In step 1204, cardless transaction processing program 182 proceeds with API authorization, as described above with respect to flow chart 600 shown in FIG. 6. In an exemplary embodiment, cardless transaction processing program 182 sends a refund request to API 140 that includes, for example, the access token, member identification, channel=SFCC, tpaID=TPA, amount, transaction identification, order identification, and/or bearer token.

In step 1206, cardless transaction processing program 182 sends a refund request to TPA 130. In an exemplary embodiment, the refund request comprises an access token, a member identification, an amount, a transaction identification, and/or a customer (i.e., user 120) order identification.

In step 1208, TPA 130 authorizes the refund.

In step 1210, TPA 130 authenticates the API call made by API 140 using an identity provider such as Auth0. In an exemplary embodiment, TPA 130 utilizes OIDC from identity provider Auth0 to verify the identity of API 140 to ensure it is from a trusted source through credentials and/or access token and/or utilizing IP whitelisting.

In step 1212, cardless transaction processing program 182 reports any payment information including balance information.

In step 1214, cardless transaction processing program 182 directs HEC retailer 150 to handle the response. In an exemplary embodiment, cardless transaction processing program 182 determines if the order was cancelled and the refund issued or order was not cancelled and refund not issued.

FIG. 13 is a block diagram of internal and external components of computing device 1300, which is representative of the computing device of FIG. 1, in accordance with an exemplary embodiment of the present disclosure. It should be appreciated that FIG. 13 provides only an illustration of one implementation and does not imply any limitations with regard to the environments in which different embodiments may be implemented. In general, the components illustrated in FIG. 13 are representative of any electronic device capable of executing machine-readable program instructions. Examples of computer systems, environments, and/or configurations that may be represented by the components illustrated in FIG. 13 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 1300 includes communications fabric 1302, which provides for communications between one or more processing units 1304, memory 1306, persistent storage 1308, communications unit 1310, and one or more input/output (I/O) interfaces 1312. Communications fabric 1302 can be implemented with any architecture designed for passing data and/or control information between processors (such as microprocessors, communications and network processors, etc.), system memory, peripheral devices, and any other hardware components within a system. For example, communications fabric 1302 can be implemented with one or more buses.

Memory 1306 and persistent storage 1308 are computer readable storage media. In this embodiment, memory 1306 includes random access memory (RAM) 1316 and cache memory 1318. In general, memory 1306 can include any suitable volatile or non-volatile computer readable storage media. Software is stored in persistent storage 1308 for execution and/or access by one or more of the respective processors 1304 via one or more memories of memory 1306.

Persistent storage 1308 may include, for example, a plurality of magnetic hard disk drives. Alternatively, or in addition to magnetic hard disk drives, persistent storage 1308 can include one or more solid state hard drives, semiconductor storage devices, read-only memories (ROM), erasable programmable read-only memories (EPROM), flash memories, or any other computer readable storage media that is capable of storing program instructions or digital information.

The media used by persistent storage 1308 can also be removable. For example, a removable hard drive can be used for persistent storage 1308. Other examples include optical and magnetic disks, thumb drives, and smart cards that are inserted into a drive for transfer onto another computer readable storage medium that is also part of persistent storage 1308.

Communications unit 1310 provides for communications with other computer systems or devices via a network. In this exemplary embodiment, communications unit 1310 includes network adapters or interfaces such as a TCP/IP adapter cards, wireless Wi-Fi interface cards, or 3G, 4G, or 5G wireless interface cards or other wired or wireless communications links. The network can comprise, for example, copper wires, optical fibers, wireless transmission, routers, firewalls, switches, gateway computers and/or edge servers. Software and data used to practice embodiments of the present disclosure can be downloaded to computing device 1300 through communications unit 1310 (i.e., via the Internet, a local area network, or other wide area network). From communications unit 1310, the software and data can be loaded onto persistent storage 1308.

One or more I/O interfaces 1312 allow for input and output of data with other devices that may be connected to computing device 1300. For example, I/O interface 1312 can provide a connection to one or more external devices 1320 such as a keyboard, computer mouse, touch screen, virtual keyboard, touch pad, pointing device, or other human interface devices. External devices 1320 can also include portable computer readable storage media such as, for example, thumb drives, portable optical or magnetic disks, and memory cards. I/O interface 1312 also connects to display 1322.

Display 1322 provides a mechanism to display data to a user and can be, for example, a computer monitor. Display 1322 can also be an incorporated display and may function as a touch screen, such as a built-in display of a tablet computer.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In an exemplary embodiment, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

REFERENCE NUMERALS

| | |
|---|---|
| 100 | Cardless transaction processing environment |
| 110 | Network |
| 120 | User |
| 130 | Third party administrator (TPA) |
| 140 | Application programming interface (API) |
| 150 | Health-E commerce (HEC) retailer |
| 160 | Open authentication (OAuth) provider |
| 170 | Fraud protection module |
| 180 | Computing device |
| 182 | Cardless transaction processing program |
| 190 | Order management module (190) |
| 200 | Flow chart |
| 202-212 | Steps |
| 250 | Flow chart |
| 252-264 | Steps |
| 300 | Flow chart |
| 302-342 | Steps |
| 400 | Flow chart |
| 402-416 | Steps |
| 500 | Flow chart |
| 502-514 | Steps |
| 600 | Flow chart |
| 602-612 | Steps |
| 700 | Flow chart |
| 702-716 | Steps |
| 800 | Flow chart |
| 802-816 | Steps |
| 900 | Flow chart |
| 902-326 | Steps |
| 1000 | Flow chart |
| 1002-1022 | Steps |
| 1100 | Flow chart |
| 1102-1124 | Steps |
| 1200 | Flow chart |
| 1202-1214 | Steps |
| 1300 | Computing device |
| 1302 | Communications fabric |
| 1304 | Processing units |
| 1306 | Memory |
| 1308 | Persistent storage |
| 1310 | Communications unit |
| 1312 | Input/output (I/O) interfaces |
| 1316 | Random access memory (RAM) |
| 1318 | Cache memory |
| 1320 | External device(s) |
| 1322 | Display |

What is claimed is:

1. A method for facilitating cardless transaction processing, comprising:
receiving a request for checkout;
determining if a balance is sufficient;
providing a frictionless payment option to a user;
receiving a valid access token;
receiving a valid bearer token;
sending a payment request to a third party administrator; and
processing the payment request.

2. The method as recited in claim 1, further comprising:
if the balance is not sufficient, providing an additional payment option to the user.

3. The method as recited in claim 1, wherein the step of receiving a valid access token comprises:
determining if a refresh token has expired;
determining if an existing access token has expired; and
if the existing access token has not expired, using the existing access token as the valid access token.

4. The method as recited in claim 3, further comprising:
if the refresh token has expired, directing the user to a log in portal.

5. The method as recited in claim 3, further comprising:
if the existing access token has expired, requesting a refresh token;
issuing a new access token and a new refresh token; and
using the new access token as the valid access token.

6. The method as recited in claim 1, wherein the step of receiving a valid bearer token comprises:
determining if an existing bearer token has expired; and
if the existing bearer token has not expired, using the existing bearer token as the valid bearer token.

7. The method as recited in claim 6, further comprising:
if the existing bearer token has expired, requesting authorization;
requesting a new bearer token;
issuing a new bearer token; and
using the new bearer token as the valid bearer token.

8. The method as recited in claim 1, further comprising:
after the step of processing the payment request; and
determining whether the user consents to the payment.

9. The method as recited in claim 1, further comprising:
after the step of processing the payment request; and
determining if an error has occurred.

10. The method as recited in claim 1, further comprising:
after the step of processing the payment request; and
determining if an insufficient payment has been received.

11. The method as recited in claim 1, further comprising:
after the step of processing the payment request; and
determining if a partial payment is required.

12. The method as recited in claim 11, further comprising:
determining that a partial payment is required; and
initiating a refund to the user if the partial payment information is either not provided in a stipulated amount of time or is declined.

13. The method as recited in claim 12, further comprising:
after the step of initiating a refund to the user, providing an additional payment option to the user.

14. The method as recited in claim 1, wherein the step of sending the payment request to the TPA comprises:
sending the valid access token, a member identification, a transaction identification, and an order identification to the TPA.

15. A computer system for facilitating cardless transaction processing, comprising:
one or more computer processors;
one or more computer readable storage media;
program instructions stored on the computer readable storage media for execution by at least one of the one or more computer processors, the program instructions comprising:
program instructions to receive a request for checkout;
program instructions to determine if a balance is sufficient;
program instructions to provide a frictionless payment option to a user;
program instructions to receive a valid access token;
program instructions to receive a valid bearer token;
program instructions to send a payment request to a third party administrator; and
program instructions to process the payment request.

16. The computer system as recited in claim 15, wherein the program instructions further comprise:
program instructions to, if the balance is not sufficient, provide an additional payment option to the user.

17. The computer system as recited in claim 15, wherein the program instructions to receive a valid access token comprise:
program instructions to determine if a refresh token has expired;
program instructions to determine if an existing access token has expired; and
program instructions to, if the existing access token has not expired, use the existing access token as the valid access token.

18. The computer system as recited in claim 17, wherein the program instructions further comprise:
program instructions to, if the refresh token has expired, directing the user to a log in portal.

19. The computer system as recited in claim 17, wherein the program instructions further comprise:
program instructions to, if the existing access token has expired, request a refresh token;
program instructions to issue a new access token and a new refresh token; and
program instructions to use the new access token as the valid access token.

20. The computer system as recited in claim 15, wherein the program instructions to receive a valid bearer token comprises:
program instructions to determine if an existing bearer token has expired; and
program instructions to, if the existing bearer token has not expired, use the existing bearer token as the valid bearer token.
